(19) United States
(12) Patent Application Publication
(10) Pub. No.: US 2023/0116547 A1
(43) Pub. Date: Apr. 13, 2023

(54) TOUCH-FREE DOCUMENT READING AT A SELF-SERVICE STATION IN A TRANSIT ENVIRONMENT

(71) Applicant: ELENIUM AUTOMATION PTY LTD, Tullamarine (AU)

(72) Inventors: Nicholas Peter OSBORNE, Doreen (AU); Aaron Jason HORNLIMANN, West Melbourne (AU)

(73) Assignee: ELENIUM AUTOMATION PTY LTD, Tullamarine (AU)

(21) Appl. No.: 17/913,675

(22) PCT Filed: Mar. 18, 2021
(86) PCT No.: PCT/AU2021/050245

§ 371 Date: Sep. 22, 2022

(30) Foreign Application Priority Data
Mar. 23, 2020 (AU) 2020900882
Mar. 24, 2020 (AU) 2020900896

(51) Int. Cl. G06F 21/32; B64F 1/36; G06V 10/74; G06V 10/82; G06V 30/10; G06V 30/41; G06V 40/16; G06V 40/60

(52) U.S. Cl. CPC G06F 21/32; B64F 1/36; G06V 10/761; G06V 10/82; G06V 30/10; G06V 30/41; G06V 40/161; G06V 40/63

(57) ABSTRACT

Embodiments generally relate to systems, methods, and processes that may use touch-free document reading at self-service interaction stations. Some embodiments relate to a self service station for conducting a passenger interaction process in transit environment, including, a display screen to display a visual prompt to present a travel document in a field of view of a video image recording device as part of the passenger interaction process, and configured to determine from the received live video images a document face image present on the travel document, to determine from the received live video images a machine-readable zone (MRZ) of the travel document and store a captured MRZ image of the MRZ, to process the captured MRZ image to determine identification information on the travel document, and store the document face image and the identification information for use in the passenger interaction process.

### CROSS-REFERENCE TO RELATED APPLICATIONS

The present application claims priority from Australian Provisional Patent Application No 2020900882 filed on 23 Mar. 2020, Australian Provisional Patent Application No 2020900896 filed on 24 Mar. 2020, the contents of which are incorporated herein by reference in their entirety.

### TECHNICAL FIELD

Embodiments generally relate to systems, methods, and processes that may use touch-free document reading at self-service interaction stations.

### BACKGROUND

As air travel becomes more affordable there are greater numbers of passengers passing through airports in order to reach their destinations. Airlines and airports offer self-service channels in order to improve the customer experience and passenger processing volume capabilities with customer convenience and more efficient use of space in an increasingly busy airport environment. As a consequence of increased people movement across borders—airports, airlines and immigration departments are acutely aware of the increased potential for transmission of contagious disease or illness to other passengers in an airport or aircraft as well as to other people in the country of travel or destination. The self-service channels often utilise computer-driven devices which require a passenger to physically touch or interact with the screen or other components of the device, thereby creating multiple transmission surfaces upon which a contagious passenger may leave residue of a contagious illness, and when a subsequent unrelated passenger comes into contact with that surface they may pick up the contagion and either become ill or pass to another surface in the airport or aircraft.

This represents a significant risk in airport situations due to the nature of a single airport having flights leaving to multiple destinations. In scenarios of contagious illness this can multiple the pandemic potential as passengers flying to different destinations around the world can all contract a contagion from a single self-service touchpoint, and then transport that contagion around the world.

There is prior existing related art which takes components of the described embodiments and utilises those components for other means.

Another such prior art system is usage of optical character recognition and image processing for the purpose of extracting text content from a document which is presented in the view of a digital video camera. This system is commonly used for scanning of documents for storage in a digital document management system, or more recently as a simpler method for entering credit card details on a smartphone by instead using the smartphone camera and optical character recognition. The prior art involving extraction of data from a travel document is commonly performed by the method of the person placing and holding their travel document on a glass-platen scanner which captures the image and performs the optical character recognition.

It is desired to address or ameliorate one or more shortcomings or disadvantages associated with prior techniques for touch-free document reading for airport customers, or to at least provide a useful alternative thereto.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

Some embodiments relate to a self-service station for conducting a passenger interaction process in a transit environment, the station including: a display screen having a display direction; a video image recording device with a field of view in the display direction; a processor to control the display of display images on the display screen and to process live video images recorded by the video image recording device; a memory accessible to the processor and storing executable program code that, when executed by the processor, causes the processor to: conduct the passenger interaction process, cause the display screen to display a visual prompt to present a travel document in the field of view as part of the passenger interaction process, receive live video images from the video image recording device, determine from the received live video images a document face image present on the travel document, determine from the received live video images a machine-readable zone (MRZ) of the travel document and store a captured MRZ image of the MRZ, process the captured MRZ image to determine identification information on the travel document, store the document face image and the identification information for use in the passenger interaction process.

The visual prompt may include a guide box sized and scaled to assist in positioning the travel document a predetermined part of the field of view.

The executable program code, when executed by the processor, may cause the processor to: cause the display screen to display the received live video images.

The executable program code, when executed by the processor, may cause the processor to: cause the display screen to display the guide box over the displayed live video images to assist positioning of the travel document in the guide box.

The executable program code, when executed by the processor, may cause the processor to: after determining the document face image and the identification information, cause the display screen to display a capture indication to indicate successful capture of information from the travel document.

The executable program code, when executed by the processor, may cause the processor to: determine a live face image in the field of view and store the live face image.

Determining the live face image may include: capturing live video images in the field of view prior to displaying the prompt, or capturing live video images in the field of view after the document face image and the identification information are stored.

The executable program code, when executed by the processor, may cause the processor to: cause the display screen to display a further prompt for a user to move the user's face in the field of view in order to determine the live face image.

The executable program code, when executed by the processor, may cause the processor to: cause the display screen to display live video images of the field of view,

The further prompt may include an overlay on the displayed live video images, the overlay illustrating a desired size or position of a user's face in the field of view.

The executable program code, when executed by the processor, may cause the processor to: compare the live face image with the document face image, determine a confidence value based on the comparison indicative of a computed confidence level that the live face image matches the document face image, and store the confidence value for use in the passenger interaction process.

The executable program code, when executed by the processor, may cause the processor to: compare the confidence value to a confidence threshold and flag a positive face image match if the confidence value is at or above the confidence threshold or flag a negative face image match if the confidence value is below the confidence threshold.

The executable program code, when executed by the processor, may cause the processor to: if the confidence value is below the confidence threshold, determine at least one further live face image in the field of view and compare the at least one further live face image to the document face image to determine at least one further confidence value.

The processing of the captured MRZ image may be performed using an optical character recognition process. The optical character recognition process may include applying a deep neural network (DNN) model that uses an EAST (Efficient and Accurate Scene Text detector) detection process.

Determining the document face image may include applying a machine learning model to the live video images.

The machine learning model may include a DNN model that uses a SSD (Single Shot Multibox Detector) process.

The executable program code, when executed by the processor, may cause the processor to: conduct the passenger interaction process as a touch-free process in which all user input to the passenger interaction process is received via the live video images.

The display screen may be non-responsive to touch.

The station may further include a housing that houses the display screen, the video image recording device, the processor and the memory, wherein the housing holds the display screen and the video image recording device at a height above floor level sufficient to allow a face of a person to be generally within the field of view when the person stands between about 1 meter and about 2.5 meters in front of the station.

Some embodiments relate to a self service station for conducting an interaction process, the station including: a display screen having a display direction; a video image recording device with a field of view in the display direction; a processor to control the display of display images on the display screen and to process live video images recorded by the video image recording device; a memory accessible to the processor and storing executable program code that, when executed by the processor, causes the processor to: conduct the interaction process, cause the display screen to display a visual prompt to present a physical document in the field of view as part of the passenger interaction process, receive live video images from the video image recording device, determine from the received live video images a personal identification image present on the physical document, determine from the received live video images a machine-readable zone (MRZ) of the physical document and store a captured MRZ image of the MRZ, process the captured MRZ image to determine identification information on the physical document, and store the personal identification image and the identification information for use in the interaction process.

Some embodiments relate to a system for touch-free interaction in a transit environment, the system including: multiple ones of the station described herein positioned to allow human interaction at one or more transit facilities; and a server in communication with each of the multiple stations to monitor operation of each of the multiple stations.

Some embodiments relate to a method of conducting a passenger interaction process on a self-service station in a transit environment, the self-service station including a display screen and a video image recording device, the method including: causing a display screen of the self-service station to display a visual prompt to present a travel document in a field of view of the video image recording device as part of the passenger interaction process; receiving live video images from the video image recording device; determining from the received live video images a document face image present on the travel document; determining from the received live video images a machine-readable zone (MRZ) of the travel document and store a captured MRZ image of the MRZ; processing the captured MRZ image to determine identification information on the travel document; and storing the document face image and the identification information for use in the passenger interaction process. The visual prompt may include a guide box sized and scaled to assist in positioning the travel document a predetermined part of the field of view.

The method may further include: causing the display screen to display the received live video images; and causing the display screen to display the guide box over the displayed live video images to assist positioning of the travel document in the guide box.

The method may further include: after determining the document face image and the identification information, causing the display screen to display a capture indication to indicate successful capture of information from the travel document.

The method may further include determining a live face image in the field of view and store the live face image.

Determining the live face image may include: capturing live video images in the field of view prior to displaying the prompt, or capturing live video images in the field of view after the document face image and the identification information are stored.

The method may further include causing the display screen to display a further prompt for a user to move the user's face in the field of view in order to determine the live face image.

The method may further include: causing the display screen to display live video images of the field of view, wherein the further prompt includes an overlay on the displayed live video images, the overlay illustrating a desired size or position of a human face in the field of view.

The method may further include: comparing the live face image with the document face image; determining a confidence value based on the comparison indicative of a computed confidence level that the live face image matches the document face image; and storing the confidence value for use in the passenger interaction process.

The method may further include: comparing the confidence value to a confidence threshold; and flagging a positive face image match if the confidence value is at or above the confidence threshold; or flagging a negative face image match if the confidence value is below the confidence threshold.

The method may further include: if the confidence value is below the confidence threshold, determining at least one further live face image in the field of view; and comparing the at least one further live face image to the document face image to determine at least one further confidence value.

The processing of the captured MRZ image may be performed using an optical character recognition process that includes applying a deep neural network (DNN) model that uses an EAST (Efficient and Accurate Scene Text detector) detection process.

Determining the document face image may include applying a machine learning model to the live video images that includes a DNN model that uses a SSD (Single Shot Multibox Detector) process.

The method may further include conducting the passenger interaction process as a touch-free process in which all user input to the passenger interaction process is received via the live video images.

### BRIEF DESCRIPTION OF DRAWINGS

FIG. 1 is a block diagram view of an interaction station system according to some embodiments;

FIG. 2 is a block diagram view of an interaction station network according to some embodiments;

FIG. 3 is a schematic illustration of a user at an interaction station according to some embodiments;

FIG. 4 is a diagram of an example travel document showing example information zones according to some embodiments;

FIG. 5 is a flow chart of a document identification process at an interaction station according to some embodiments;

FIG. 6 is a flow chart of a document identity matching process at an interaction station according to some embodiments; and

FIG. 7 is a schematic block diagram of a computer system architecture that can be employed according to some embodiments.

### DETAILED DESCRIPTION

Embodiments generally relate to systems, methods, and processes that use touch-free document reading at self-service interaction stations.

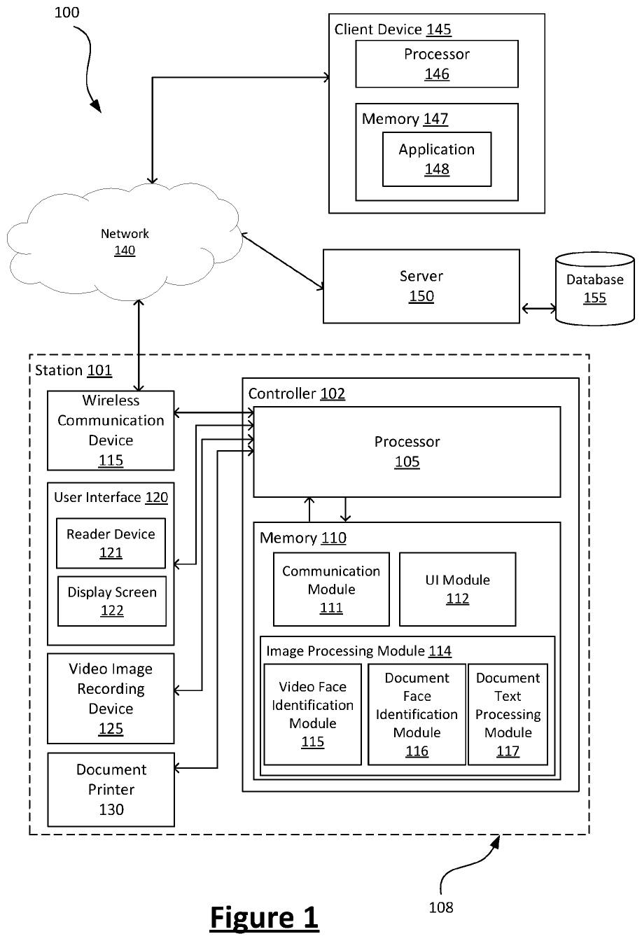

Referring to FIGS. 1 to 7, a self-service station 101 is described, together with systems of which the self-service system may form a part and the processes executed by the station 101. In some embodiments, a self-service interaction station 101 is provided to facilitate users conducting interaction processes. Such interaction processes may include passenger interaction processes such as check-in processes for impending travel, incoming or outgoing immigration or customs processes, travel or event reservation processes or information querying processes, for example.

Multiple stations 101 may be connected to a client device 145 and database 155 over a network 140. Each station 101 is configured to identify the documents and faces of users 1.1 interacting with the station, through a video image recording device 125. The station 101 is further configured to analyse documents within the field of view 1.5 of the video image recording device 125 in order to interact with the user interface 120 to conduct an interaction process.

FIG. 1 is a block diagram of a system 100 for managing self-service interaction stations, comprising a station 101, a server 150, a database 155 accessible to the server 150, and at least one client device 145. Station 101 is in communication with server 150 and client device 145 over a network 140.

In the embodiments illustrated by FIG. 1, station 101 comprises a controller 102. The controller 102 comprises a processor 105 in communication with a memory 110 and arranged to retrieve data from the memory 110 and execute program code stored within the memory 110. The components of station 101 may be housed in a housing 108. Station 101 may be connected to network 140, and in communication with client device 145, server 150, and database 155.

Processor 105 may include more than one electronic processing device and additional processing circuitry. For example, processor 105 may include multiple processing chips, a digital signal processor (DSP), analog-to digital or digital-to analog conversion circuitry, or other circuitry or processing chips that have processing capability to perform the functions described herein. Processor 105 may execute all processing functions described herein locally on the station 101 or may execute some processing functions locally and outsource other processing functions to another processing system, such as server 150.

The network 140 may comprise at least a portion of one or more networks having one or more nodes that transmit, receive, forward, generate, buffer, store, route, switch, process, or a combination thereof, etc. one or more messages, packets, signals, some combination thereof, or so forth. The network 140 may include, for example, one or more of: a wireless network, a wired network, an internet, an intranet, a public network, a packet-switched network, a circuit-switched network, an ad hoc network, an infrastructure network, a public-switched telephone network (PSTN), a cable network, a cellular network, a satellite network, a fiber optic network, some combination thereof, or so forth.

Server 150 may comprise one or more computing devices configured to share data or resources among multiple network devices . Server 150 may comprise a physical server, virtual server, or one or more physical or virtual servers in combination.

Database 155 may comprise a data store configured to store data from network devices over network 140. Database 155 may comprise a virtual data store in a memory of a computing device, connected to network 140 by server 150.

Station 101 may further comprise a wireless communication device 115, user interface 120, video image recording device 125, and document printer 130.

Wireless communication device 115 may comprise a wireless Ethernet interface, SIM card module, Bluetooth connection, or other appropriate wireless adapter allowing wireless communication over network 140. Wireless communication device 115 may be configured to facilitate communication with external devices such as client device 145 and server 150. In some embodiments, a wired communication means is used.

User interface 120 is configured to allow a user to initiate and interact with an interaction process hosted by the user interface 120. User interface 120 may comprise a reader device 121 to enable image based or wireless reading or scanning of documents (other than travel documents as described herein), cards or devices where necessary or helpful to provide information for the interaction process. In some embodiments, the interaction process comprises a series of steps allowing a user 1.1 to provide identification details to the station 101 to retrieve booking details and/or undertake a check-in process. The interaction process may comprise a series of steps wherein the user 1.1 provides booking details to the station 101 to identify themselves. The interaction process may take between 1 and 20 minutes, for example. In some embodiments, the interaction process comprises a passenger interaction process.

The user interface 120 may further comprise a display screen 122, configured to allow a user to be shown content during the interaction process. Such content may include a series of actionable items, buttons, information related to a booking, or other appropriate information, in order to conduct the interaction process. In some embodiments, display screen 122 comprises a touch screen. In other embodiments, display screen 122 may be non-responsive to touch.

Video image recording device 125 may comprise a digital video camera (DVC), arranged to capture images of an area from which the user interface 120 is accessible. In other words, the video image recording device 125 captures images from a facing direction that is the same direction that the display screen 122 faces. An image capture aperture of the video image recording device 125 may be positioned at or adjacent a top or bottom edge of the display screen 122. The video image recording device 125 may have an image resolution of about 1280×720 pixels (known as 720 p) or greater, for example. The display resolution of the display screen 122 may be less than the image resolution of the video image recording device 125 since display resolution is of particular importance. However, various suitable levels of resolution can be used for display screen 122.

Document printer 130 may comprise a printer configured to allow for printing user documents as a result of the interaction process. In some embodiments, the document printer 136 prints boarding passes, receipts, or other documentation related to the user or the interaction process.

The memory 110 may further comprise executable program code that defines a communication module 111, user interface (UI) module 112, and image processing module 114. The memory 110 is arranged to store program code relating to the communication of data from memory 110 over the network 140.

Communication module 111 may comprise program code, which when executed by the processor 105, implements instructions related to initiating and operating the wireless communication device 115. When initiated by the communication module 111, the wireless communication device 115 may send or receive data over network 140. Communication module 111 may be configured to package and transmit data generated by the UI module 112 and/or retrieved from the memory 110 over network 140 to a client device 145, and/or to server 150. In some embodiments, this transmitted data includes an alert, relating to a person identified by image capture device 130. In some embodiments, the alert relates to a status of the interaction process.

UI module 112 may comprise program code, which when executed by the processor 105, implements instructions relating to the operation of user interface 120. UI module 112 may be configured to implement instructions related to the position of a user's 1.1 head within a field of view of the video image recording device 125. In such embodiments, the UI module 112 may receive instructions from the user interface 120 or image processing module 114 about advancing, reverting, or otherwise interacting with stages of an interaction process.

Image processing module 114 may comprise program code, which when executed by the processor 105, implements instructions relating to the operation of the video image recording device 125. When initiated by the image processing module 114, the video image recording device 125 may activate and transmit a stream of captured video frames to the processor 105. Image processing module 114 may further comprise video face identification module 115, document face identification module 116, and document text processing module 117. In such embodiments, the video image recording device 125 may transmit a stream of live video frames to the processor 105, wherein the image frames are processed by the modules 115, 116, and 117 in order to identify details of a user 1.1.

Video face identification module 115 may comprise program code, which when executed by the processor 105, implements instructions configured to identify the face of a user 1.1 within a series of video image frames.

Document face identification module 116 may comprise program code, which when executed by the processor 105, implements instructions configured to identify a face image of a person on a document within a video image frame.

In some embodiments, the face of a user 1.1 identified in a series of live video frames by video face identification module 115 may be compared against a face identified in a document by document face identification module 116 for a match. The matching process may be undertaken by image processing module 114. In some embodiments, a confidence threshold is assigned to the matching process, such as a confidence score of say 95% or 99%, in order to determine a match.

Document text processing module 117 may comprise program code, which when executed by the processor 105, implements instructions configured to identify a text string in an image of a document within a video image frame. In some embodiments, the text string may comprise a text string within a machine readable zone of an identification document such as a passport, immigration form, vehicle license, or other form of identification.

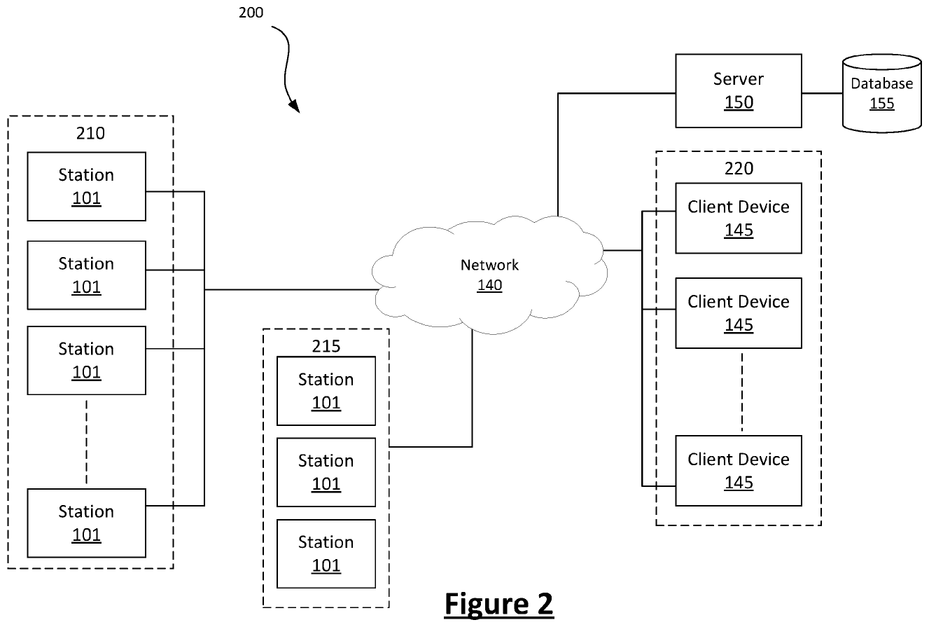

FIG. 2 depicts a block diagram of a self-service station network 200 according to some embodiments. The network 200 comprises an individual self-service station bank or array 210, a separately located self-service station bank or array 215, server 150, database 155, and client device array 220. The individual self-service station array 210 may comprise at least one self-service station 101 individually connected to network 140. In some embodiments, the stations 101 of array 210 are located together at a single installation site, such as an airport check-in, or an airport customs or immigration area. In other embodiments, the stations 101 of array 210 may be separately located throughout a number of individual sites throughout an airport, or may be located at multiple installation sites, such as a series of airports. In some embodiments, the locations of installation of array 210 comprise self-service facilities including, but not limited to, self-service check-in kiosks, self-service bag drop, automated departure gate boarding gates, automated immigration entry or exit gates, airline lounge gates, or other appropriate self-service areas, for example.

The client device array 220 may comprise at least one client device 145 connected individually to network 140. In some embodiments, the array 220 comprises any combination of smartphones, tablet computing devices, personal computers, or other devices capable of sending instructions over network 140 and executing instructions from memory 147.

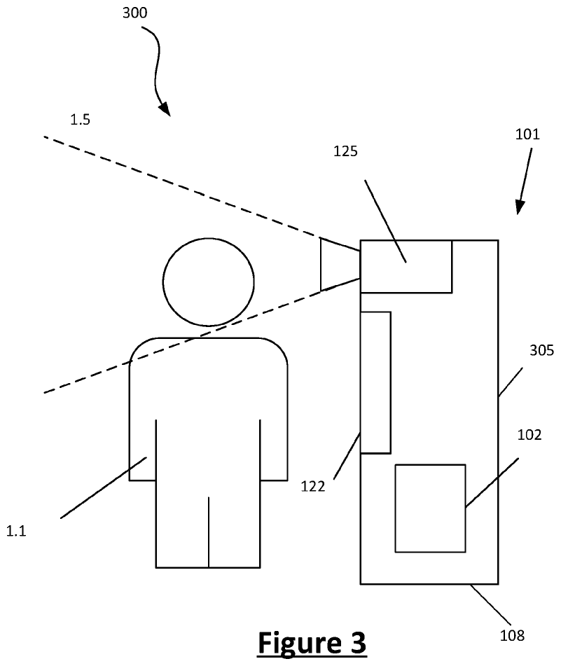

FIG. 3 depicts a diagram of a user 1.1 interacting with a self-service interaction station 101. The self-service station 101 further comprises a housing 108 that in some embodiments includes a solid upstanding cabinet 305 defining internal space to house the components of station 101 described herein. In other embodiments, the station 101 may be housed or positioned in a wall or wall cavity or may form part of a barrier, pedestal or other upstanding structure, for example. In such embodiments, the housing 108 is partly or wholly provided by the wall, wall cavity, barrier, pedestal or other upstanding structure. The housing 108 houses the display screen 122, the video image recording device 125, the processor 102 and the memory. The housing 108 holds the display screen 122 and the video image recording device 125 at a height above floor level (i.e. a bottom extent of the housing 108) sufficient to allow a face of a person to be generally within the field of view when the person stands between about 1 meter and about 2.5 meters in front of the station. The display screen 122 may be held by the housing 108 so that the bottom edge of the display screen 122 is at a height of between about 1.3 and about 1.6 metres above floor level, for example. The display screen 122 may have a top edge about 0.2 to about 0.5 metres above the bottom edge, for example. A light-receiving aperture of the video image recording device 125 may be positioned at or slightly above the top edge of the display screen, for example.

In FIG. 3, user 1.1 is at least partially within the field of view 1.5 of the video image recording device 125. The video image recording device 125 may be positioned to ensure the field of view 1.5 defines an area substantially facing the direction from which the user interface 120 may be accessed by a user 1.1. In some embodiments, the user 1.1 may be an airline passenger, airline or airport staff, or other individual at an airport requiring self-service interaction or check-in processes. In some embodiments, the user 1.1 may be a train, ship or other transport passenger, staff, or other individual requiring self-service interaction or check-in processes for transport purposes. In some embodiments, the user 1.1 may be an event participant, attendee at a secure facility or other person requiring self-service check-in processes.

In some embodiments, the field of view 1.5 defines a horizontal range of approximately 1 meter either side of the anticipated position of a user 1.1 (standing at between about 1 metre and about 2.5 metres from the display screen) using the user interface 120. In some embodiments, the field of view 1.5 defines a vertical range of about 0.5 meters above and below the anticipated position (standing at between about 1 metre and about 2.5 metres from the display screen) of a user 1.1 using the interface 120.

In some embodiments, the field of view 1.5 is substantially centred at an anticipated average height of an adult person who would be accessing the user interface 120. The field of view 1.5 may extend in a horizontal and vertical area to cover other people close to the user 1.1. In some embodiments, other appropriate ranges may be defined. In other embodiments, the field of view 1.5 may be arranged to be substantially centred at the anticipated area of the upper portions of a user 1.1. The upper portions of a user 1.1 are intended to include at least the user's chest, neck, face, and head. The field of view 1.5 may comprise an area aligned with the facing direction of the display screen 122.

In other embodiments, the field of view 1.5 may be dynamically altered by the video image recording device 125 to be extended, shrunk or laterally or vertically shifted in accordance with user specified requirements. The user specified requirements may be configurable by an operator to allow individual stations 101 to have an optimised field of view 1.5 depending on their installation position, angle, and lighting.

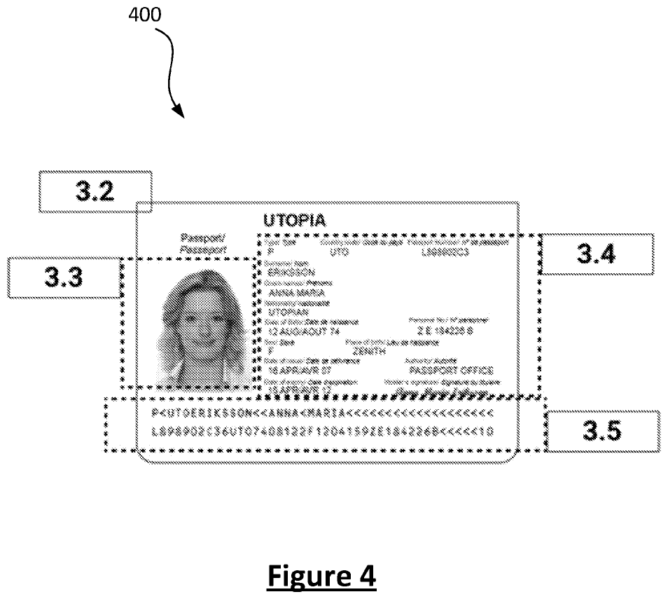

FIG. 4 is an example document field diagram according to some embodiments, comprising document area 3.2, a face image region 3.3, Visual Inspection Zone (VIZ) 3.4, and Machine Readable Zone (MRZ) 3.5. In some embodiments, document face identification module 116 is configured to identify a face located within the face image region 3.3 within document area 3.2. In some embodiments, document text processing module 117 is configured to identify a text string within machine readable zone 3.5. In other embodiments, document text recognition module 117 may be configured to identify text strings in other sections of the document area 3.2.

In the example of FIG. 4, the depicted document is the identification page of a passport. Image processing module 114 may be configured with document field layouts, allowing the submodules 115, 116, and 117 to scan specific regions of the document within the image frame. The arrangement of face image region 3.3, VIZ 3.4, and MRZ 3.5 may vary depending on the type of document identified within the field of view 1.5. In some embodiments, a library of document layouts may be stored within image processing module 114 for comparison with presented documents. Such embodiments may be employed where station 101 is reasonably likely to be presented with multiple different document types. In other embodiments, the document presented by the person in the field of view 1.5 may include other personal identification documents including, but not limited to, travel visa permits, state-issued drivers licenses, state-issued identity cards, and any other personal identification document or card which may include a face image of the person and identifying information regarding the holder of the document or card.

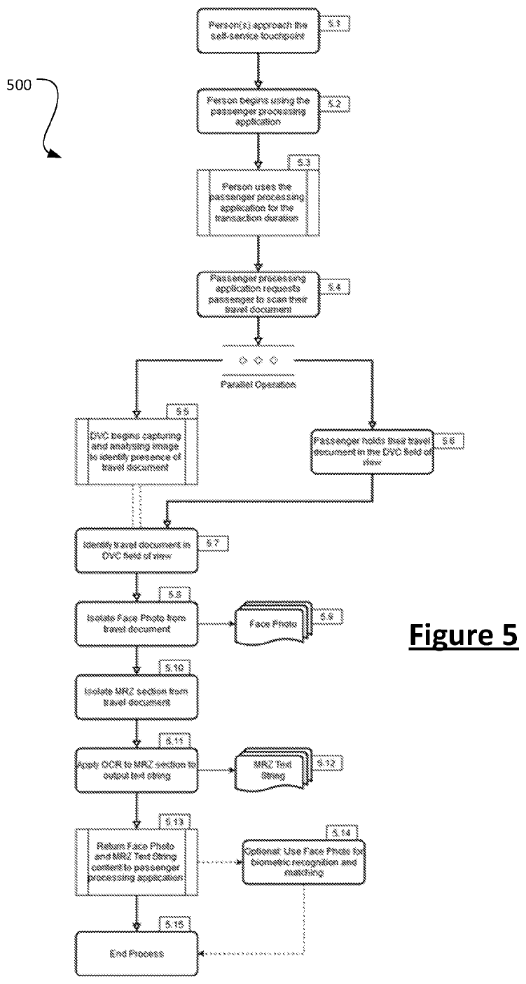

FIG. 5 is a flow chart of a touch-free document identification process 500 at an interaction station according to some embodiments. At step 5.1, user 1.1 may approach the self-service station 101 until they enter the field of view 1.5 of the video image recording device 125. Once a user 1.1 enters the field of view 1.5, they may be prompted to initiate an interaction process by a prompt on display screen 122. The prompt may be issued by a passenger processing application within or external to UI module 112.

In some embodiments, the video image recording device 125 continuously sends a live stream of video image frames to be analysed by image processing module 114 to detect the presence of a user. In such embodiments, the detection of a face within the image frame for a configurable period of time may indicate a user 1.1 is ready to begin an interaction process at the station 101. In some embodiments, the period of time is between about 3 to 4 seconds. In other embodiments, the period of time may be between about 2 to 5 seconds. In other embodiments, a face proximity detection system may be implemented by image processing module 114 in order to determine that a person is standing at a distance indicating they intend to use the station 101. In some embodiments, this distance may be between about 1 metre to about 2.5 metres away from the station 101. In other embodiments, the distance may be between about 0.5 metres to 1 metre or about 0.5 meters to about 2.5 metres, for example. In such embodiments, the image processing module 114 may analyse the pixel dimensions of a face within the image frame in order to initiate a prompt to begin the interaction process at the user interface 120.

At step 5.2, the user 1.1 begins an interaction process at station 101 using user interface 120. In some embodiments, this interaction may comprise the touch-free document identification process as depicted in the flow chart of FIG. 5. In other embodiments, the steps of identifying and analysing a document within the field of view 1.5 comprise a sub-process of a different interaction process. In some embodiments the process may be an entirely touch-free interaction process. In other embodiments, the process may be a touch-based interaction process, with the document identification part of the interaction process comprising a touch-free sub-process. At this step 5.2, the processor 105 may receive live video images from the video image recording device 125.

At step 5.3, the user 1.1 continues to interact with the touch-free interaction process at station 101 until step 5.4, wherein they are prompted to scan their identity document for recognition. During step 5.3, the image processing module 114 may use touch-free feature tracking methods, or touch-free gesture tracking methods in order for a user 1.1 to interact with (provide input to) the interaction process. In some embodiments, these may comprise feature tracking techniques as described in Australian Provisional Patent Application number 2020900882 filed on 23 Mar. 2020, the contents of which is incorporated herein by reference. In some embodiments, the interaction process comprises a check-in process for a flight or other travel. In some embodiments, the interaction process comprises a check-in for attendance at a site or for an event.

At step 5.4, the passenger may be prompted to present a document for validation and verification. In some embodiments, the required document may be a passport, boarding pass, or other travel related document. At step 5.5 the image processing module 114 may begin to analyse video images from the video image recording device 125 in order to identify when a compatible travel document is being held in the field of view 1.5. Concurrently, at step 5.6 the user would be requested to hold their travel document upright within the field of view 1.5 so that it faces the display screen 122 (and therefore also the video image recording device 125). Once a requested travel document has been identified by the image processing module 114, the document face identification module 116 and document text processing module 117 may analyse the image to extract the data required by the application within UI module 112. In step 5.4 and/or 5.5 and/or 5.6, the image processing module 114 determines whether the travel document is close enough to the video image recording device 125. This determination may be based on the total size of the travel document in the image frame. If the travel document is determined to be outside of a distance threshold, the user may be directed by the user interface 120 to hold the travel document closer or farther away from the station 101. In some embodiments, the distance threshold is between about 0.5 metres and about 1 metre or between about 0.5 metres to about 2.5 metres. In other embodiments, the distance threshold may be about 1 metre to about 2.5 metres.

At step 5.7, the user's travel document is identified within field of view 1.5 by image processing module 114. The image processing module 114 may then apply a document field layout to the identified document to enable processing by modules 116 and 117 to identify faces and text from the relevant document regions.

A passenger travel document may be a passport issued by the passenger's nation of origin or other nation, or a visa issued by an origin, destination or transit country, for example. Travel documents can be designed in accordance with the International Civil Aviation Organisation (ICAO) specifications for Machine-Readable Travel Documents (MRTDs). An example MRTD 400 is depicted in FIG. 4, which consists of multiple distinct regions 3.3., 3.4, 3.5 that can be imaged separately.

In some embodiments, for the purpose of travel document verification and validation the image processing module 114 seeks to isolate only specific sections of the document. FIG. 4 depicts an example of a ICAO-compliant MRTD 400. The MRTD 400 comprises a face image (usually based on a photo), which is an identifying image of the document holder used for identity verification. The face image within region 3.3 may also be used for biometric verification processes, as described below. The example travel document 400 shown in FIG. 4 includes a Visual Inspection Zone (VIZ) in region 3.4, which may contain human-readable data regarding the document holder (e.g. name, date of birth, nationality, expiry, etc.), and the Machine Readable Zone (MRZ) in region 3.5 which contains text data in a machine-readable format of similar semantic content to the VIZ at 3.4. Step 5.4 and step 5.7 may comprise determining, from the received live video images, a document face image present on the travel document. Step 5.7 comprises determining, from the received live video images, a machine-readable zone (MRZ) of the travel document and store a captured MRZ image of the MRZ.

At step 5.8, a face image may be isolated from the document (from region 3.3 for example) and stored as a document face image file 5.9 within memory 110 by the document face identification module 116. In some embodiments, the document face identification module 116 isolates faces within the frame using a machine learning-based model pre-trained to identify the location of the face image within a document. In some embodiments, the document may comprise an International Civil Aviation Organisation (ICAO) compliant machine readable travel document (MRTD).

In some embodiments, document face identification module 116 uses a machine learning-based model to detect faces. In such embodiments, the model used to detect the face of a person may be a deep neural net (DNN)-based model based on a SSD framework (Single Shot MultiBox Detector), for example. The SSD framework may use a reduced ResNet-10 model (“res10_300×300_ssd_iter_140000”), for example. In other embodiments, any analogous (or improved) model used for face detection may be used alone or in addition to the aforementioned model.

At step 5.10, the image processing module 114 may analyse and process the MRZ (from region 3.5 for example) of a document, using document text processing module 117. The isolation of the MRZ section may be performed by the document text processing module 117 using a machine learning-based model pre-trained to identify locations of the MRZ section within an ICAO-compliant MRTD.

The document text processing module 117 may then perform an Optical Character Recognition (OCR) process at step 5.11 in order to convert the text in the isolated MRZ section image to text string output 5.12 which may be captured and stored within memory 110. In some embodiments, the OCR process may include applying a deep neural network (DNN) model to extract features from the MRZ section image, for example. The DNN model may use an EAST (Efficient and Accurate Scene Text detector) detection process, for example.

The image processing module 114 may then provide the document face image file 5.9 and MRZ text string 5.12 to the application within UI module 112. In some embodiments, the application within UI module 112 is a passenger processing application. In such embodiments, the outputs of the document face identification module 116 and document text processing module 117 provide the same outputs to the passenger processing application as a glass-platen document reader, configured to scan passport documents.

The steps 5.7 to 5.12 may comprise processing the captured MRZ image to determine identification information on the travel document. Steps 5.13 to 5.15 may comprise storing the document face image and the identification information for use in the passenger interaction process.

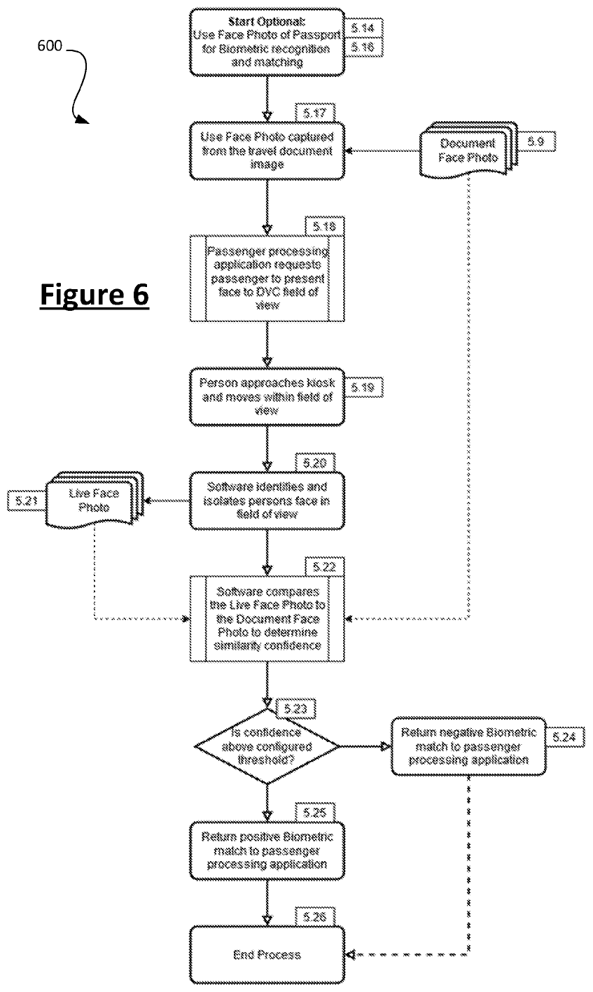

The image processing module may perform biometric recognition and matching as part of the process 500 at steps 5.14, 5.16 to verify that the person standing in the field-of-view 1.5 is the same person as captured in the document face image file 5.9. FIG. 6 depicts an embodiment of a biometric recognition process 600.

At step 5.15, the process 500 concludes. In some embodiments this concludes the interaction process at the station 101. In such embodiments, an indication to the user 1.1 is given through the display screen 122 that the interaction process has concluded. In other embodiments, the completion of process 500 comprises the end of the touch-free document identification process and the resumption of a different or original interaction process.

FIG. 6 is a flow chart of an document identity matching process 600 at an interaction station according to some embodiments. Process 600 may commence at step 5.14 of the process 500.

At step 5.16, when the document face identification module 116 has captured and stored the document face image file 5.9 from the travel document, the application within UI module 112 may optionally attempt to perform biometric matching between the document face image file 5.9 and the user 1.1 that is using the self-service station 101 and currently standing in the field-of-view 1.5.

For the purpose of biometric matching, the UI module 112 may cause the display screen 122 to request the user 1.1 to move their face into a region of the field-of-view 1.5 so that a live face image frame 5.21 can be captured. During this time, the display screen 122 may be controlled by UI module 112 to display content (in the form of text and/or imagery) to the person to assist with user experience by displaying a live video view of the field-of-view 1.5 that includes the person. In some embodiments, this content may comprise a transparent overlay showing the outline of the desired size of the person's face on the display screen 122 within the field-of-view 1.5. This may encourage the user 1.1 to move into an optimal position at step 5.19 for capture of the live face image frame 5.21. When the user 1.1 moves into the encouraged position in the field of view 1.5 at step 5.19, the video face identification module 115 may utilise a pre-trained machine learning-based model to identify and isolate the face of the person in the field of view. The video face identification module 115 may then capture and store one or more live face image frames 5.21 in memory 110.

In some embodiments, video face identification module 115 uses a machine learning-based model to detect faces in a live video feed. In such embodiments, the model used to detect the face of a person may be a deep neural net (DNN)-based model, for example based on a SSD framework (Single Shot MultiBox Detector) using a reduced ResNet-10 model (“res10_300×300_ssd_iter_140000”). In other embodiments, any analogous model used for face detection may be used alone or in addition to the aforementioned model.

At step 5.22, the image processing module 114 may then perform the process of comparing the face captured in live face image frame 5.21 and the face captured in the document face image file 5.9 to determine a confidence that the two faces are of the same person. To perform this process, the image processing module 114 may encode the face in each image into a biometric token created by comparing various elements of two separate face images. This may include, but is not limited to, comparing distance between elements like eye-to-eye distance, eye size, eye-to-ear distance, nose-to-mouth distance, mouth size, mouth-to-chin distance, or other appropriate anatomical distances. In some embodiments, the biometric tokens may be expressed as ratios by image processing module 114, in order to accommodate any differences between the scale or resolution of the live face image frame 5.21 and the document face image frame 5.9. In other embodiments, image processing module 114 may apply a scaling factor to the pixel dimensions of either face image in order to accurately compare the two face images.

The biometric tokens of the images may be compared by the image processing module 114. The comparison may determine a confidence of similarity as a 0% to 99.999% confidence percentage. This confidence percentage may be compared to the currently configured confidence threshold at step 5.23. The confidence threshold may be stored in memory 110 and set at 90%, 95%, 99%, for example, or another appropriate confidence threshold percentage in order to accurately assess a match.

The confidence threshold may be configured as a percentage decimal in the range of 0% to 99.999% and determines at what confidence rating a successful face match is determined. The confidence threshold may be modified based on feedback and observations during usage and may vary from installation to installation based on the determined usage of the biometric face matching system. The default confidence threshold may be 90% for non-security applications, for example, and may be increased as the intended security risk implication increases. In police or security applications, a confidence threshold of 95% or higher may be used, for example. If the confidence rating determined by the face matching process at step 5.22 is equal to or higher than the configured threshold in step 5.23, then the image processing module 114 returns a positive match result at step 5.25 to the application within UI module 112.

If a confidence rating determined by the face matching process at step 5.22 is below the configured threshold at step 5.23, then the image processing module 114 will return a negative match result at step 5.24 to the application within UI module 112.

If a confidence rating determined by the face matching process at step 5.22 is below the configured threshold at step 5.23, the image processing module 114 may determine at least one further live face image in the field of view 1.5 and compare the at least one further live face image to the document face image frame 5.9 to determine at least one further confidence value.

In some embodiments, a positive biometric face match may allow a user 1.1 to continue or conclude an interaction process at station 101. In other embodiments, a negative biometric face match may prevent a user 1.1 from continuing or concluding an interaction process at station 101. In such embodiments, the user 1.1 may be provided further attempts at achieving a positive face match, owing to potential machine error. In some embodiments, continuation of the interaction process by a negatively matched user 1.1 may require approval by a nearby officer or operator. In some embodiments, the result of the biometric face match may be sent over network 140 to a client device 145, or to database 155 by server 150, for example where the match has a negative outcome. However, in some embodiments, the person undergoing the interaction process at the station 101 is not notified by the station 101 of the outcome of the biometric matching, whether positive or negative. This may allow the nearby officer to discretely approach the person and assist the process or ask the person to step aside for an interview or further processing.

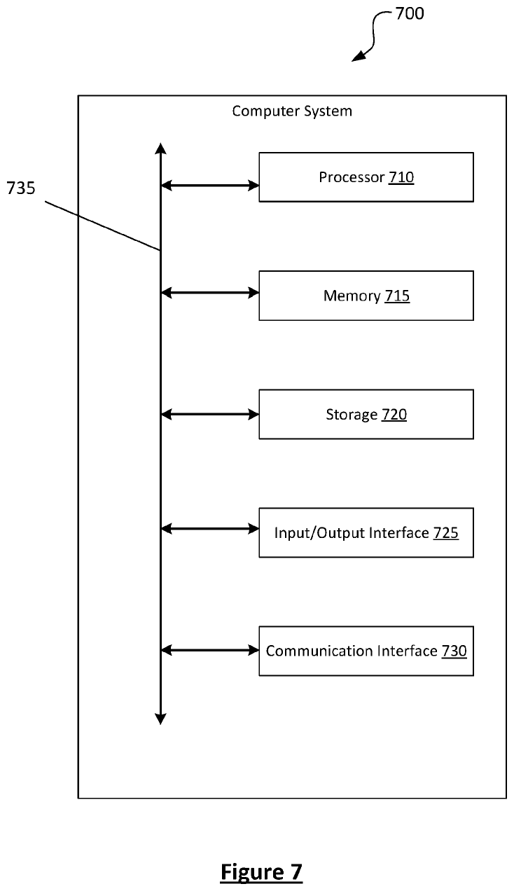

FIG. 7 illustrates an example computer system 700 according to some embodiments. In particular embodiments, one or more computer systems 700 perform one or more steps of one or more methods described or illustrated herein. In particular embodiments, one or more computer systems 700 provide functionality described or illustrated herein. In particular embodiments, software running on one or more computer systems 700 performs one or more steps of one or more methods described or illustrated herein or provides functionality described or illustrated herein. Particular embodiments include one or more portions of one or more computer systems 700. Herein, reference to a computer system may encompass a computing device, and vice versa, where appropriate. Moreover, reference to a computer system may encompass one or more computer systems, where appropriate. Controller 102 is an example of computer system 700.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a special-purpose computing device, a desktop computer system, a laptop or notebook computer system, a mobile telephone, a server, a tablet computer system, or a combination of two or more of these. Where appropriate, computer system 700 may: include one or more computer systems 700; be unitary or distributed; span multiple locations; span multiple machines; span multiple data centers; or reside partly or wholly in a computing cloud, which may include one or more cloud computing components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes at least one processor 710, memory 715, storage 720, an input/output (I/O) interface 725, a communication interface 730, and a bus 735. Processor 105 is an example of processor 710. Memory 110 is an example of memory 715. Memory 110 may also be an example of storage 720. Although this disclosure describes and illustrates a particular computer system having a particular number of particular components in a particular arrangement, this disclosure contemplates any suitable computer system having any suitable number of any suitable components in any suitable arrangement.

In particular embodiments, processor 710 includes hardware for executing instructions, such as those making up a computer program. As an example and not by way of limitation, to execute instructions, processor 710 may retrieve (or fetch) the instructions from an internal register, an internal cache, memory 715, or storage 720; decode and execute them; and then write one or more results to an internal register, an internal cache, memory 715, or storage 720. In particular embodiments, processor 710 may include one or more internal caches for data, instructions, or addresses. This disclosure contemplates processor 710 including any suitable number of any suitable internal caches, where appropriate. As an example and not by way of limitation, processor 710 may include one or more instruction caches, one or more data caches, and one or more translation lookaside buffers (TLBs). Instructions in the instruction caches may be copies of instructions in memory 715 or storage 720, and the instruction caches may speed up retrieval of those instructions by processor 710. Data in the data caches may be copies of data in memory 715 or storage 720 for instructions executing at processor 710 to operate on; the results of previous instructions executed at processor 710 for access by subsequent instructions executing at processor 710 or for writing to memory 715 or storage 720; or other suitable data. The data caches may speed up read or write operations by processor 710. The TLBs may speed up virtual-address translation for processor 710. In particular embodiments, processor 710 may include one or more internal registers for data, instructions, or addresses. This disclosure contemplates processor 710 including any suitable number of any suitable internal registers, where appropriate. Where appropriate, processor 710 may include one or more arithmetic logic units (ALUs); be a multi-core processor; or include one or more processors 710. Although this disclosure describes and illustrates a particular processor, this disclosure contemplates any suitable processor.

In particular embodiments, memory 715 includes main memory for storing instructions for processor 710 to execute or data for processor 710 to operate on. As an example and not by way of limitation, computer system 700 may load instructions from storage 720 or another source (such as, for example, another computer system 700) to memory 715. Processor 710 may then load the instructions from memory 715 to an internal register or internal cache. To execute the instructions, processor 710 may retrieve the instructions from the internal register or internal cache and decode them. During or after execution of the instructions, processor 710 may write one or more results (which may be intermediate or final results) to the internal register or internal cache. Processor 710 may then write one or more of those results to memory 715. In particular embodiments, processor 710 executes only instructions in one or more internal registers or internal caches or in memory 715 (as opposed to storage 720 or elsewhere) and operates only on data in one or more internal registers or internal caches or in memory 715 (as opposed to storage 720 or elsewhere). One or more memory buses (which may each include an address bus and a data bus) may couple processor 710 to memory 715. Bus 735 may include one or more memory buses, as described below. In particular embodiments, one or more memory management units (MMUs) reside between processor 710 and memory 715 and facilitate accesses to memory 715 requested by processor 710. In particular embodiments, memory 715 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 715 may include one or more memories 715, where appropriate. Although this disclosure describes and illustrates particular memory, this disclosure contemplates any suitable memory.

In particular embodiments, storage 720 includes mass storage for data or instructions. As an example and not by way of limitation, storage 720 may include a hard disk drive (HDD), a floppy disk drive, flash memory, an optical disc, a magnetooptical disc, magnetic tape, or a Universal Serial Bus (USB) drive or a combination of two or more of these. Storage 720 may include removable or non-removable (or fixed) media, where appropriate. Storage 720 may be internal or external to computer system 700, where appropriate. In particular embodiments, storage 720 is non-volatile, solid-state memory. In particular embodiments, storage 720 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 720 taking any suitable physical form. Storage 720 may include one or more storage control units facilitating communication between processor 710 and storage 720, where appropriate. Where appropriate, storage 720 may include one or more storages 720.

Although this disclosure describes and illustrates particular storage, this disclosure contemplates any suitable storage. In particular embodiments, I/O interface 725 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 725 for them. Where appropriate, I/O interface 725 may include one or more device or software drivers enabling processor 710 to drive one or more of these I/O devices. I/O interface 725 may include one or more I/O interfaces 725, where appropriate. Although this disclosure describes and illustrates a particular I/O interface, this disclosure contemplates any suitable I/O interface.

In particular embodiments, communication interface 730 includes hardware, software, or both providing one or more interfaces for communication (such as, for example, packet-based communication) between computer system 700 and one or more other computer systems 700 or one or more networks. As an example and not by way of limitation, communication interface 730 may include a network interface controller (NIC) or network adapter for communicating with a wireless adapter for communicating with a wireless network, such as a WI-FI or a cellular network. This disclosure contemplates any suitable network and any suitable communication interface 730 for it. As an example and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless cellular telephone network (such as, for example, a Global System for Mobile Communications (GSM) network, or a 3G, 4G or 5G cellular network), or other suitable wireless network or a combination of two or more of these. Computer system 700 may include any suitable communication interface 730 for any of these networks, where appropriate. Communication interface 730 may include one or more communication interfaces 730, where appropriate. Although this disclosure describes and illustrates a particular communication interface, this disclosure contemplates any suitable communication interface.

In particular embodiments, bus 735 includes hardware, software, or both coupling components of computer system 700 to each other. As an example and not by way of limitation, bus 735 may include an Accelerated Graphics Port (AGP) or other graphics bus, an Enhanced Industry Standard Architecture (EISA) bus, a frontside bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 735 may include one or more buses 735, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, (FDDs), solid-state drives (SSDs), RAM-drives, or any other suitable computer-readable non-transitory storage media, or any suitable combination of two or more of these, where appropriate. A computer-readable non-transitory storage medium may be volatile, non-volatile, or a combination of volatile and non-volatile, where appropriate.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A self service station for conducting a passenger interaction process in a transit environment, the station including:
a display screen having a display direction;
a video image recording device with a field of view in the display direction;
a processor to control the display of display images on the display screen and to process live video images recorded by the video image recording device;
a memory accessible to the processor and storing executable program code that, when executed by the processor, causes the processor to:
conduct the passenger interaction process,
cause the display screen to display a visual prompt to present a travel document in the field of view as part of the passenger interaction process,
receive live video images from the video image recording device,
determine from the received live video images a document face image present on the travel document,
determine from the received live video images a machine-readable zone (MRZ) of the travel document and store a captured MRZ image of the MRZ,
process the captured MRZ image to determine identification information on the travel document,
store the document face image and the identification information for use in the passenger interaction process.

2. The station of claim 1, wherein the visual prompt includes a guide box sized and scaled to assist in positioning the travel document a predetermined part of the field of view.

3. The station of claim 2, wherein the executable program code, when executed by the processor, causes the processor to:
cause the display screen to display the received live video images.

4. The station of claim 3, wherein the executable program code, when executed by the processor, causes the processor to:
cause the display screen to display the guide box over the displayed live video images to assist positioning of the travel document in the guide box.

5. The station of any one of claims 1 to 4, wherein the executable program code, when executed by the processor, causes the processor to:
after determining the document face image and the identification information, cause the display screen to display a capture indication to indicate successful capture of information from the travel document.

6. The station of any one of claims 1 to 5, wherein the executable program code, when executed by the processor, causes the processor to:
determine a live face image in the field of view and store the live face image.

7. The station of claim 6, wherein determining the live face image includes: capturing live video images in the field of view prior to displaying the prompt, or capturing live video images in the field of view after the document face image and the identification information are stored.

8. The station of claim 6 or claim 7, wherein the executable program code, when executed by the processor, causes the processor to:
cause the display screen to display a further prompt for a user to move the user's face in the field of view in order to determine the live face image.

9. The station of claim 8, wherein the executable program code, when executed by the processor, causes the processor to:
cause the display screen to display live video images of the field of view,
wherein the further prompt includes an overlay on the displayed live video images, the overlay illustrating a desired size or position of a user's face in the field of view.

10. The station of claims 6 to 9, wherein the executable program code, when executed by the processor, causes the processor to:
compare the live face image with the document face image,
determine a confidence value based on the comparison indicative of a computed confidence level that the live face image matches the document face image, and
store the confidence value for use in the passenger interaction process.

11. The station of claim 10, wherein the executable program code, when executed by the processor, causes the processor to:
compare the confidence value to a confidence threshold and flag a positive face image match if the confidence value is at or above the confidence threshold or flag a negative face image match if the confidence value is below the confidence threshold.

12. The station of claim 11, wherein the executable program code, when executed by the processor, causes the processor to:
if the confidence value is below the confidence threshold, determine at least one further live face image in the field of view and compare the at least one further live face image to the document face image to determine at least one further confidence value.

13. The station of any one of claims 1 to 12, wherein the processing of the captured MRZ image is performed using an optical character recognition process.

14. The station of claim 13, wherein the optical character recognition process includes applying a deep neural network (DNN) model that uses an EAST (Efficient and Accurate Scene Text detector) detection process.

15. The station of any one of claims 1 to 14, wherein determining the document face image includes applying a machine learning model to the live video images.

16. The station of claim 15, wherein the machine learning model includes a DNN model that uses a SSD (Single Shot Multibox Detector) process.

17. The station of any one of claims 1 to 16, wherein the executable program code, when executed by the processor, causes the processor to:
conduct the passenger interaction process as a touch-free process in which all user input to the passenger interaction process is received via the live video images.

18. The station of claim 17, wherein the display screen is non-responsive to touch.

19. The station of any one of claims 1 to 18, further including a housing that houses the display screen, the video image recording device, the processor and the memory, wherein the housing holds the display screen and the video image recording device at a height above floor level sufficient to allow a face of a person to be generally within the field of view when the person stands between about 1 meter and about 2.5 meters in front of the station.

20. A self service station for conducting an interaction process, the station including:
a display screen having a display direction;
a video image recording device with a field of view in the display direction;
a processor to control the display of display images on the display screen and to process live video images recorded by the video image recording device;
a memory accessible to the processor and storing executable program code that, when executed by the processor, causes the processor to:
conduct the interaction process,
cause the display screen to display a visual prompt to present a physical document in the field of view as part of the passenger interaction process,
receive live video images from the video image recording device,
determine from the received live video images a personal identification image present on the physical document,
determine from the received live video images a machine-readable zone (MRZ) of the physical document and store a captured MRZ image of the MRZ,
process the captured MRZ image to determine identification information on the physical document,
store the personal identification image and the identification information for use in the interaction process.

21. A system for touch-free interaction, the system including:
multiple ones of the station of any one of claims 1 to 20 positioned to allow human interaction at one or more facilities; and
a server in communication with each of the multiple stations to monitor operation of each of the multiple stations.

22. A method of conducting a passenger interaction process on a self-service station in a transit environment, the self-service station including a display screen and a video image recording device, the method including:
causing a display screen of the self-service station to display a visual prompt to present a travel document in a field of view of the video image recording device as part of the passenger interaction process;
receiving live video images from the video image recording device;
determining from the received live video images a document face image present on the travel document;
determining from the received live video images a machine-readable zone (MRZ) of the travel document and store a captured MRZ image of the MRZ;
processing the captured MRZ image to determine identification information on the travel document; and
storing the document face image and the identification information for use in the passenger interaction process.

23. The method of claim 22, wherein the visual prompt includes a guide box sized and scaled to assist in positioning the travel document a predetermined part of the field of view.

24. The method of claim 23, further including:
causing the display screen to display the received live video images; and
causing the display screen to display the guide box over the displayed live video images to assist positioning of the travel document in the guide box.

25. The method of any one of claims 22 to 24, further including:
after determining the document face image and the identification information, causing the display screen to display a capture indication to indicate successful capture of information from the travel document.

26. The method of any one of claims 22 to 25, further including determining a live face image in the field of view and store the live face image.

27. The method of claim 26, wherein determining the live face image includes: capturing live video images in the field of view prior to displaying the prompt, or capturing live video images in the field of view after the document face image and the identification information are stored.

28. The method of claim 26 or claim 27, further including causing the display screen to display a further prompt for a user to move the user's face in the field of view in order to determine the live face image.

29. The method of claim 28, further including:
causing the display screen to display live video images of the field of view,
wherein the further prompt includes an overlay on the displayed live video images, the overlay illustrating a desired size or position of a human face in the field of view.

30. The method of claims 26 to 29, further including:
comparing the live face image with the document face image;
determining a confidence value based on the comparison indicative of a computed confidence level that the live face image matches the document face image; and
storing the confidence value for use in the passenger interaction process.

31. The method of claim 30, further including:
comparing the confidence value to a confidence threshold; and
flagging a positive face image match if the confidence value is at or above the confidence threshold; or
flagging a negative face image match if the confidence value is below the confidence threshold.

32. The method of claim 31, further including:
if the confidence value is below the confidence threshold, determining at least one further live face image in the field of view; and
comparing the at least one further live face image to the document face image to determine at least one further confidence value.

33. The method of any one of claims 22 to 32, wherein the processing of the captured MRZ image is performed using an optical character recognition process that includes applying a deep neural network (DNN) model that uses an EAST (Efficient and Accurate Scene Text detector) detection process.

34. The method of any one of claims 22 to 33, wherein determining the document face image includes applying a machine learning model to the live video images that includes a DNN model that uses a SSD (Single Shot Multibox Detector) process.

35. The method of any one of claims 22 to 34, further including conducting the passenger interaction process as a touch-free process in which all user input to the passenger interaction process is received via the live video images.

36. The steps, systems, devices, subsystems, features, integers, methods and/or processes disclosed herein or indicated in the specification of this application individually or collectively, and any and all combinations of two or more of said steps, systems, devices, subsystems, features, integers, methods and/or processes.
